(19) United States
(12) Patent Application Publication
(10) Pub. No.: US 2008/0252218 A1
(43) Pub. Date: Oct. 16, 2008

(54) Low-Pressure Mercury Vapor Discharge Lamp

(75) Inventor: Lars Rene Christian Waumans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,596

(22) PCT Filed: Jan. 19, 2005
(86) PCT No.: PCT/IB2005/050221

§ 371 Date: Aug. 1, 2006

(30) Foreign Application Priority Data
Feb. 5, 2004 (EP) 04100421.9

(51) Int. Cl. H05B 37/00; H01J 61/72

(52) U.S. Cl. 315/86; 313/637

(57) ABSTRACT

A low-pressure mercury vapor discharge lamp is operable in a first mode of operation (“normal mode”) and a second mode of operation (“emergency operation”). The discharge lamp comprises a discharge vessel (10) enclosing a discharge space (13) provided with a filling of mercury and an inert gas. The discharge vessel comprises electrodes (5;6) for maintaining a discharge in the discharge space while the discharge lamp operates in the first mode of operation. According to the invention, at least one of the electrodes is operated on a DC or AC power supply for drawing a discharge current (D₁;D₂) over the electrode while the discharge lamp operates in the second mode of operation. Preferably, both electrodes operate on a DC or AC power supply, preferably a battery, while the discharge lamp operates in the second mode of operation. The low-pressure mercury vapor discharge lamps operated according to the invention have a relatively long life.

The invention relates to a low-pressure mercury vapor discharge lamp being operable in a first and a second mode of operation.

In mercury vapor discharge lamps, mercury constitutes the primary component for the (efficient) generation of ultraviolet (UV) light. A luminescent layer comprising a luminescent material may be present on an inner wall of the discharge vessel to convert UV to other wavelengths, for example to UV-B and UV-A for tanning purposes (sun panel lamps) or to visible radiation for general illumination purposes. Such discharge lamps are therefore also referred to as fluorescent lamps. Alternatively, the ultraviolet light generated may be used for manufacturing germicidal lamps (UV-C). The discharge vessel of low-pressure mercury vapor discharge lamps is usually circular and comprises both elongate and compact embodiments. Generally, the tubular discharge vessel of compact fluorescent lamps comprises a collection of relatively short straight parts having a relatively small diameter, which straight parts are connected together by means of bridge parts or via bent parts. Compact fluorescent lamps are usually provided with an (integrated) lamp cap. Normally, the means for maintaining a discharge in the discharge space are electrodes arranged in the discharge space. In an alternative embodiment, the low-pressure mercury vapor discharge lamp comprises a so-called electrodeless low-pressure mercury vapor discharge lamp.

In many buildings, emergency lighting systems have been installed. An emergency lighting system generally comprises a fluorescent lamp, a ballast and a low-voltage power supply, for instance a battery pack. Under normal conditions, the fluorescent lamp obtains power from the mains power system of the building. In the description and claims of this invention, this “normal mode” of operation will also be referred to as the “first mode of operation”. When, during an emergency, a mains power failure occurs (e.g. in case of a fire, a fire alarm or other calamity), the low-voltage power supply (battery pack) takes over the power supply and the fluorescent lamp will still burn. In the description and claims of this invention, this “emergency mode” of operation will also be referred to as the “second mode of operation”. In the second mode of operation, the fluorescent lamp emits light for guiding persons in the building to safe places in case of an emergency situation.

Low-pressure mercury vapor discharge lamps as mentioned in the opening paragraph are well known in the art. A disadvantage of the known low-pressure mercury vapor discharge lamp is that the life of the discharge lamp is relatively low in the emergency mode.

The invention has for its object to wholly or partly eliminate the above disadvantage. According to the invention, a low-pressure mercury vapor discharge lamp of the kind mentioned in the opening paragraph therefore comprises:

a discharge vessel enclosing, in a gastight manner, a discharge space provided with a filling of mercury and an inert gas,

the discharge vessel comprising electrodes arranged in the discharge space for maintaining a discharge in the discharge space while the discharge lamp operates in the first mode of operation,

at least one of the electrodes being operated on a DC or AC power supply for drawing a discharge current across the electrode while the discharge lamp operates in the second mode of operation.

According to the invention, a current is drawn between one side of the electrode and the other side of the electrode when the discharge lamp operates in the second mode of operation (“emergency mode”). This is the so-called arcing effect. This electrode arcing is achieved by operating the electrode under DC or AC current conditions. By sending and tuning a current through the electrode, the electrode is operated in its “normal” regime. In this manner, excessive electrode degradation during emergency operation is reduced and reduction of the life of the discharge lamp is avoided.

In the known low-pressure mercury vapor discharge lamp, the discharge lamp in the second mode of operation (“emergency mode”) operates on a relatively low current (less than 10% of the nominal current). Like in the “normal mode”, the low current in the “emergency mode” in the known discharge lamp is maintained between the electrodes. However, the electrodes in the discharge lamp are not designed for such a low current. This leads to a fast and substantial degradation of electrode material primarily due to sputtering. Such electrode degradation reduces the life of the known discharge lamp considerably. This would not be a problem if the emergency light were operational only during emergency conditions. However, (government) safety regulations require that emergency lighting systems must be regularly and frequently tested (typically at least once a month). During testing, the known emergency lighting system is operated for some time in the emergency mode. This frequent testing gives rise to early failure of the emergency lighting system as compared to normal fluorescent lamps.

Low-pressure mercury vapor discharge lamps operated according to the invention have a relatively long life.

Preferably, both electrodes operate on a DC or AC power supply while the discharge lamp operates in the second mode of operation. When the discharge lamp operates in the second mode of operation (“emergency mode”), a current is drawn between one side of each electrode and the other side of each electrode. In this favourable embodiment, electrode arcing is achieved simultaneously at both electrodes. By sending and tuning a current through each electrode, each electrode can be operated in its “normal” regime. In this manner, excessive electrode degradation during emergency operation is reduced and reduction of the life of the discharge lamp is avoided. By operating both electrodes on a DC or AC power supply, the light output of the discharge lamp is approximately doubled with respect to the situation when only one of the electrodes is operated on a power supply while the discharge lamp operates in the second mode of operation.

A preferred embodiment of the low-pressure mercury vapor discharge lamp according to the invention is characterized in that, while the lamp operates in the second mode of operation, the electrodes are independent with respect to each other. When the discharge lamp operates in the first mode of operation, the discharge lamp is normally operated in a so-called bridge circuit assembly. Such a bridge circuit assembly implies the electrical interconnection between one side of one electrode and one side of the other electrode in the discharge vessel.

In another preferred embodiment of the low-pressure mercury vapor discharge lamp, the discharge lamp, while operating in the second mode of operation, is electrically disconnected from the power supply on which the discharge lamp operates in the first mode of operation. In this manner, the discharge lamp, while operating in the second mode of operation, is free from interference with the circuit assemblies on which the discharge lamp is operated in the first mode of operation.

A favorable embodiment of the low-pressure mercury vapor discharge lamp according to the invention is characterized in that when a power failure occurs while the discharge lamp operates in the first mode of operation, the second mode of operation causes the discharge lamp to operate in the second mode of operation. Preferably, a means associated with the second mode of operation detects the power failure when the discharge lamp is in the first mode of operation. The means detects the power failure in the first mode of operation and causes the start of the second mode of operation. Preferably, the means also causes or initiates the disconnection of the discharge lamp from the power supply on which the discharge lamp operates in the first mode of operation.

Yet another preferred embodiment of the low-pressure mercury vapor discharge lamp according to the invention is characterized in that the discharge lamp, while operating in the second mode of operation, operates on a current that is less than 20% of the nominal current when the discharge lamp operates in the first mode of operation.

The discharge lamp according to the invention has an additional advantage. If the known discharge lamp is operated in the second mode of operation (“emergency operation”) the voltage across the lamp is relatively high due to the relatively low current between the electrodes in the discharge vessel and the negative voltage-current characteristic of the discharge. In the discharge lamp according to the invention, the electrodes are operated on their nominal lamp current while the discharge lamp operates in the second mode of operation (“emergency operation”). The length of the discharge (“arc”) drawn between two sides of the electrode is much shorter than the length of a discharge drawn between two electrodes at opposite ends of the discharge vessel. In the discharge lamp according to the invention, this leads to a reduction of the voltage across the lamp. Such a relatively low lamp voltage substantially simplifies the ballast and the battery pack when the discharge lamp operates in the second mode of operation. To this end, a preferred embodiment of the low-pressure mercury vapor discharge lamp according to the invention is characterized in that the discharge lamp is powered by a battery while operating in the second mode of operation.

These and other aspects of the invention are apparent from and will be elucidated with reference to the embodiments described hereinafter.

In the drawings:

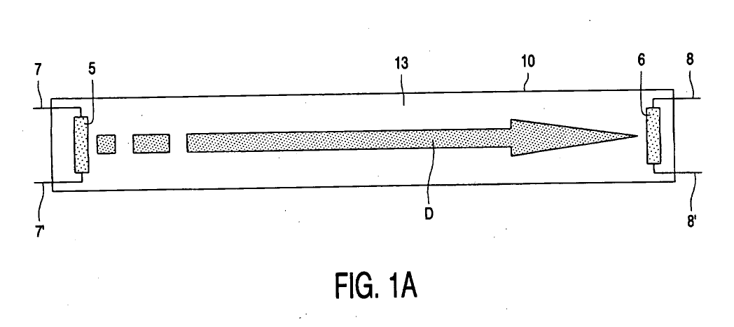

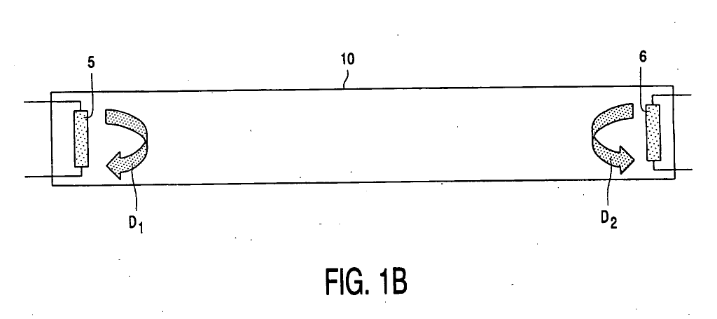

FIG. 1A is a cross-sectional view of a low-pressure mercury-vapor discharge lamp in a first mode of operation, and

FIG. 1B is a cross-sectional view of a low-pressure mercury vapor discharge lamp in a second mode of operation.

The Figs. are purely diagrammatic and not drawn to scale. Notably, some dimensions are shown in a strongly exaggerated form for the sake of clarity. Similar components in the Figures are denoted as much as possible by the same reference numerals.

FIG. 1A very schematically shows a low-pressure mercury vapor discharge lamp comprising a glass discharge vessel having a tubular portion, which discharge vessel transmits radiation generated in the discharge vessel 10. The discharge vessel 10 encloses, in a gastight manner, a discharge space 13 containing a filling of mercury and an inert gas mixture comprising for example argon. In fluorescent discharge lamps, the side of the tubular portion 11 facing the discharge space 13 is coated with a luminescent layer (not shown in FIG. 1A) including a luminescent material (for example a fluorescent powder) which converts the ultraviolet (UV) light generated by fallback of the excited mercury into (generally) visible light. In addition, the side of the tubular portion 11 facing the discharge space 13 is provided with one of more protective layer(s) (not shown in FIG. 1A).

The low-pressure mercury vapor discharge lamp is operable in a first and a second mode of operation. The first mode of operation is normally called the “normal mode” of operation, while the second mode of operation is normally called the “emergency mode” of operation. In the example of FIG. 1A, the discharge vessel 10 comprises electrodes 5; 6 arranged in the discharge space 13 for maintaining a discharge D in the discharge space 13 while the discharge lamp operates in the first mode of operation. The electrodes 5; 6 are supported by end portions of the discharge vessel 10. The electrode 5; 6 is a winding of tungsten covered with an electron-emitting substance, in this case a mixture of barium oxide, calcium oxide and strontium oxide. Current-supply conductors 7, 7′; 8, 8′ of the electrodes 5; 6, respectively, pass through the end portions and issue from the discharge vessel 10 to the exterior.

FIG. 1A shows the discharge lamp operating in the first mode of operation (“normal mode”): a discharge D is drawn between the electrodes 5; 6. FIG. 1B shows the discharge lamp operating in the second mode of operation (“emergency mode”): the electrodes 5; 6 are operated on a DC power supply or on an AC power supply for drawing a discharge current D₁; D₂ across the electrode 5; 6 while the discharge lamp operates in the second mode of operation. In the example of FIG. 1B a discharge current D1; D2 is drawn across both electrodes 5; 6.

Preferably, while the lamp operates in the second mode of operation, the electrodes are independent with respect to each other. When the discharge lamp operates in the first mode of operation, the discharge lamp is normally operated in a so-called full-bridge circuit assembly or in a so-called half-bridge circuit assembly. Such circuit assemblies are known to the person skilled in the art. Both operational schemes imply the electrical interconnection between one side of one electrode and one side of the other electrode in the discharge vessel; normally one side of one electrode is connected via a capacitor to one side of the other electrode.

Preferably, the discharge lamp, while operating in the second mode of operation, is electrically disconnected from the power supply on which the discharge lamp operates in the first mode of operation. In this manner, the discharge lamp, while operating in the second mode of operation, is free from interference with the circuit assemblies on which the discharge lamp is operated in the first mode of operation.

When a power failure occurs while the discharge lamp operates in the first mode of operation, the second mode of operation, preferably, causes the discharge lamp to operate in the second mode of operation. In addition, a means associated with the second mode of operation detects the power failure when the discharge lamp is in the first mode of operation. The means detects the power failure in the first mode of operation and causes the start of the second mode of operation. Preferably, the means also causes or initiates the disconnection of the discharge lamp from the power supply on which the discharge lamp operates in the first mode of operation.

Preferably, the discharge lamp, while operating in the second mode of operation, operates on a current that is less than 20% of the nominal current when the discharge lamp operates in the first mode of operation.

In the known emergency lighting systems, the luminous flux in the emergency mode is roughly 10% of the luminous flux in the normal operation mode. In the emergency lighting system according to the invention, a luminous flux in the range from 5 to 40 lm can be obtained for each electrode. The luminous flux is dependent on the type of discharge lamp.

The discharge lamp according to the invention has an additional advantage. If the known discharge lamp is operated in the second mode of operation (“emergency operation”) the voltage across the lamp is relatively high due to the relatively low current between the electrodes in the discharge vessel and the negative voltage-current characteristic of the discharge. In the discharge lamp according to the invention, the electrodes are operated on their nominal lamp current while the discharge lamp operates in the second mode of operation (“emergency operation”). The length of the discharge (“arc”) drawn between two sides of the electrode is much shorter than the length of a discharge drawn between two electrodes at opposite ends of the discharge vessel. In the discharge lamp according to the invention, this leads to a reduction of the voltage across the lamp. Preferably, this voltage is in the range from approximately 15 to approximately 20 V. Such a low lamp voltage substantially simplifies the ballast when the discharge lamp operates in the second mode of operation (due to the absence of a transformer). Preferably, the discharge lamp is powered by a battery while operating in the second mode of operation. Preferably, two 9V batteries connected in series are used to operate the lamp in the second mode of operation (“emergency mode”).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, a number of these means may be embodied by one and the same item of hardware. The mere fact that certain measures are recited in mutually different dependent claims does not indicate that a combination of these measures cannot be used to advantage.

1. A low-pressure mercury-vapor discharge lamp being operable in a first and a second mode of operation, the discharge lamp comprising:
a discharge vessel (10) enclosing, in a gastight manner, a discharge space (13) provided with a filling of mercury and an inert gas,
the discharge vessel (10) comprising electrodes (5; 6) arranged in the discharge space (13) for maintaining a discharge in the discharge space (13) while the discharge lamp operates in the first mode of operation,
at least one of the electrodes (5; 6) being operated on a DC or AC power supply for drawing a discharge current across the electrode (5; 6) while the discharge lamp operates in the second mode of operation.

2. A low-pressure mercury vapor discharge lamp as claimed in claim 1, characterized in that both electrodes (5; 6) operate on a DC or AC power supply while the discharge lamp operates in the second mode of operation.

3. A low-pressure mercury vapor discharge lamp as claimed in claim 1, characterized in that, while the lamp operates in the second mode of operation, the electrodes (5; 6) are independent with respect to each other.

4. A low-pressure mercury vapor discharge lamp as claimed in claim 1, characterized in that the discharge lamp, while operating in the second mode of operation, is electrically disconnected from the power supply on which the discharge lamp operates in the first mode of operation.

5. A low-pressure mercury vapor discharge lamp as claimed in claim 1, characterized in that when a power failure occurs while the discharge lamp operates in the first mode of operation, the second mode of operation causes the discharge lamp to operate in the second mode of operation.

6. A low-pressure mercury vapor discharge lamp as claimed in claim 5, characterized in that a means associated with the second mode of operation detects the power failure when the discharge lamp is in the first mode of operation.
